(19) United States
(12) Patent Application Publication
(10) Pub. No.: US 2008/0310329 A1
(43) Pub. Date: Dec. 18, 2008

(54) Method and Apparartus for Mitigating Psp Interference Psp-Enabled Communication Systems

(75) Inventors: Li Sun, Shanghai (CN); Qunli Jia, Shanghai (CN); Xuejun Zhang, Shanghai (CN)

Correspondence Address: PHILIPS INTELLECTUAL PROPERTY & STANDARDS, PO BOX 3001, BRIARCLIFF MANOR, NY, 10510-8001, US

(73) Assignee: Koninklijke Philips Electronics N.V.

(21) Appl. No.: 10/578,930

(22) PCT Filed: Nov. 3, 2004
(86) PCT No.: PCT/IB04/52317

§ 371 Date: May 8, 2006

(30) Foreign Application Priority Data
Nov. 10, 2003 (CN) 200310115658.9

(51) Int. Cl. H04J 3/00

(52) U.S. Cl. 370/280

(57) ABSTRACT

A method to be performed by a network system is proposed, for P2P communication to cancel interference, comprising steps of: determining the redundant code group information, according to the code group usage information of the cell in which two UEs to establish P2P connection camp and its adjacent cells; detecting the relative position between said two UEs and each of other active UEs in communication state in the cell where said two UEs are camping and its adjacent cells; if at least one UE of said two UEs causes radio interference to at least one of said active UEs according to the relative position, further determining whether said UE and said active UE are assigned in the same time slot; selecting a scrambling code from the redundant code group information and assigning it to said two UEs if said UE and said active are assigned in the same time slot, so that said two UEs can perform scrambling operation by using said scrambling code on P2P signals transferred between said two UEs.

### FIELD OF THE INVENTION

The present invention relates generally to a communication method and apparatus for TDD CDMA (Time Division Duplex Code Division Multiple Access) communication systems, and more particularly, to a method and apparatus for mitigating P2P interference in P2P-enabled communication systems.

### BACKGROUND OF THE INVENTION

In conventional cellular mobile communication systems, a UE (user equipment) has to communicate with another UE only through the relaying of base stations regardless of the distance between the two UEs. FIG. 1 illustrates this conventional communication mode, where UE1 and UE2 exchange information through the UTRAN consisting of the base station transceiver (namely Node B) and the RNC, and this communication mode is also called UP-UTRAN-DOWN mode. However, in some cases when the distance between two UEs in the same cell is very close, it can be a more reasonable way for them to communicate directly, rather than through the relaying of base stations. This method is the so-called peer-to-peer communication, abbr. as P2P.

FIG. 2 illustrates a P2P communication mode. As shown in FIG. 2, where the dashed line represents signaling link, the solid line represents data link and the arrowhead represents direction of information flow. Only signaling link exists between the UTRAN and the UE, while only data link exists between the two communicating UEs. Assume that only resource for maintaining basic communication is needed. If a direct link is taken as one unit of radio resource (with fixed frequency, timeslot and spreading code), it can be easily drawn that P2P communication mode only needs two units of radio resource to maintain basic communication. If additional signaling cost for management is ignored, P2P communication can save about 50% radio resource than conventional communication mode. Meanwhile, the UTRAN still holds control over P2P communication, especially over how to use radio resources, so that network operators can easily charge for the radio resource used in P2P communication.

It is commonly accepted that a Time Division Duplex (TDD) air interface is a communication standard that offers a more flexible adaptation to different uplink and downlink traffic requirements. Among existing 3G systems based on TDD communication scheme, TD-SCDMA (Time Division—Synchronization Code Division Multiple Access) system is an ideal communication system to be most suitable for the combination of P2P communication with conventional communication mode, because the same carrier frequency is applied in both uplink and downlink communications, which can simplify the RF (Radio Frequency) module of the user equipment.

A method and apparatus for establishing P 2P communication in wireless communication networks, as described in the patent application entitled “A Method and Apparatus for Establishing P2P Communication in Wireless Communication Networks”, filed by KONINKLIJKE PHILIPS ELECTRONICS N. V. on Mar. 7^{th}, 2003, with the application Serial NO. 03119892.9, is suitable to any TDD CDMA communication system including TD-SCDMA systems, and incorporated herein as reference.

A method and apparatus for radio link establishment and maintenance with P2P communication in wireless communication networks, as described in the patent application entitled “A Method and Apparatus for Radio Link Establishment and Maintenance with P2P Communication in Wireless Communication Networks”, filed by KONINKLIJKE PHILIPS ELECTRONICS N. V. on Mar. 7^{th}, 2003, with the application Serial NO. 03119895.3, is suitable to any radio communication system including TD-SCDMA systems, and incorporated herein by reference.

After establishing uplink synchronization with the UTRAN through the same random access procedure as existing TD-SCDMA systems, the UE can establish a P2P direct link with another UE, with the method and apparatus as described in the patent application with the application Serial NO. 03119892.9, i.e.: allocating corresponding dedicated resource for two P2P UEs. Then, a direct link between the two UEs can be established and maintained in accordance with the method and apparatus as described in the patent application with the application NO. 03119895.3, so that the two UEs can receive and transmit P2P signals in the allocated timeslots respectively, and thus P2P communication between two UEs can be achieved.

However, the introduction of P2P communication changes the conventional UP-UTRAN-DOWN communication mode in TD-SCDMA communication systems. Thus, when conventional link shares the same timeslot with P2P link, conventional uplink and/or downlink communications will unavoidably produce interference with the communication in P2P link, which will likely deteriorate the performance of P2P-enabled TDD CDMA communication systems seriously.

FIG. 3 shows the various possible interferences caused by introducing P2P in TD-SCDMA communication systems. Signal S2 sent from UE A to UE B shares the same uplink timeslot with signal S1 sent from UE C to base station B, so UE B can receive P2P signals from UE A as well as radio signals from UE C when UE B receives signals in the uplink timeslot if it falls within the radio range of UE C, and at this time, signal S1 sent by UE C becomes interfering signal I1 for UE B, and signal S2 sent by UE A becomes interfering signal I2 for the base station. Similarly, if UE C falls within the P2P radio range of UE B, when signal S4 sent from UE B to UE A shares the same downlink timeslot with signal S3 sent from base station B to UE C, signal S4 becomes interfering signal I4 for UE C while signal S3 becomes interfering signal I3 for UE A. Moreover, when radio interference is produced between P2P communicating pair UE A-B and P2P communicating pair UE D-E by sharing the same timeslots, there are interfering signals I5 and 16.

As for the above interfering signal I2, detailed descriptions are respectively given to two methods and apparatuses for mitigating interfering signal I2, as proposed in the patent application entitled “A Method and Apparatus for Maintaining Uplink Synchronization with P2P Communication in Wireless Communication Networks”, filed by KONINKLIJKE PHILIPS ELECTRONICS N.V. on Mar. 7, 2003, with the application Serial NO. 03119894.5, and another patent application entitled “A Method and Apparatus for Maintaining Uplink Synchronization with P2P Communication in Wireless Communication Networks”, filed by KONINKLIJKE PHILIPS ELECTRONICS N.V. on May 19, 2003, with the application Serial NO. 03123738. X, and incorporated herein by reference.

A method and apparatus is proposed for mitigating interfering signal I3, as described in another patent application entitled “A Method and Apparatus for Supporting P2P Communication in TDD CDMA Communication Systems”, filed by KONINKLIJKE PHILIPS ELECTRONICS N.V. on Apr. 11^{th}, 2003, with the application Serial NO. 03110415.0, and incorporated herein by reference.

As for the above interfering signals I1, I4, I5 and I6, an intelligent dynamic channel allocation method and apparatus is proposed for mitigating interfering signals I1, I4, I5 and I6, as described in another patent application entitled “A Method and Apparatus for Supporting P2P Communication in TDD CDMA Communication Systems”, filed by KONINKLIJKE PHILIPS ELECTRONICS N.V. on May 19, 2003, with the application Serial NO. 03123740.1, and incorporated herein by reference.

The basic principle of the intelligent dynamic channel allocation method is: when the UEs performing P2P communication via P2P link fall within the radio range of other UEs or other UEs fall within the radio range of the UEs performing P2P communication via P2P link, different timeslots can be allocated to these UEs by using the intelligent dynamic channel allocation method, to avoid the above interfering signals I1, I4, I5 and I6 caused by sharing the same timeslots.

But according to communication protocols, each TD-SCDMA sub-frame only has 7 timeslots and with one timeslot of those for downlink common control channel, so only 6 timeslots is actually available in each sub-frame. Assumed that when two UEs are performing P2P communication, two different timeslots are needed for their P2P link. According to the above intelligent dynamic channel allocation method, in the radio range of the two P2P communicating UEs, only two pairs of UEs can establish two pairs of P2P links (using 4 different timeslots) at the same time. This could not satisfy practical requirement in many cases such as in hot spots, and therefore impose limitations on P2P applications, especially when the supported P2P radio range increases.

### SUMMARY OF THE INVENTION

An object of the present invention is to provide a method and apparatus for mitigating P2P interference in P2P-enabled communication systems, capable of effectively mitigating the above interfering signals I1, I4, I5 and I6 caused by introducing P2P communication mode in TDD CDMA communication systems.

An other object of the present invention is to provide a method and apparatus for mitigating P2P interference in P2P-enabled communication systems, capable of effectively mitigating the above interfering signals I2 and I3 caused by introducing P2P communication mode in TDD CDMA communication systems.

A method for mitigating P2P interference in accordance with the present invention, performed by a network system, comprises: determining the redundant code group information, according to the code group usage information of the cell on which two UEs attempting to establish P2P link are camping and its adjacent cells; detecting the relative position between said two UEs and each of other active UEs in communication state in said cell where said two UEs are camping and its adjacent cells; if radio interference is caused between at least one of said two UEs and at least one of said active UEs according to the relative position, further determining whether said UE and said active UE are allocated in the same timeslot; if said UE and said active UE are allocated in the same timeslot, selecting a scrambling code from the redundant code group information and assigning it to said two UEs, so that said two UEs can perform scrambling operation by using said scrambling code on P2P signals to be transferred between said two UEs.

A method for mitigating P2P interference in accordance with the present invention, performed by a UE, comprises: acquiring the code group usage information of the cell where said UE is camping through cell search procedure; reading the code group usage information of its adjacent cells through adjacent cell search procedure; sending the code group usage information of the cell where said UE is camping and its adjacent cells to the network system; receiving a scrambling code assigned by said network system, said scrambling code being assigned to said UE by said network system through selecting from the redundant code group information determined by said network system according to said code group usage information; and performing scrambling operation by using said scrambling code on P2P signals to be sent or the received P2P signals.

### BRIEF DESCRIPTION OF THE DRAWINGS

For a detailed description of the preferred embodiments of the invention, reference will now be made to the accompanying drawings in which:

FIG. 1 is a schematic diagram illustrating two UEs communicate through the relaying of base stations in conventional communication mode;

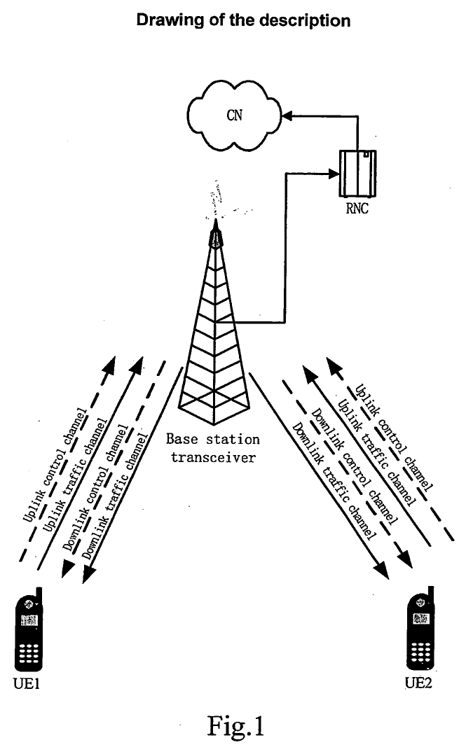

FIG. 2 is a schematic diagram illustrating two UEs communicate in P2P communication mode;

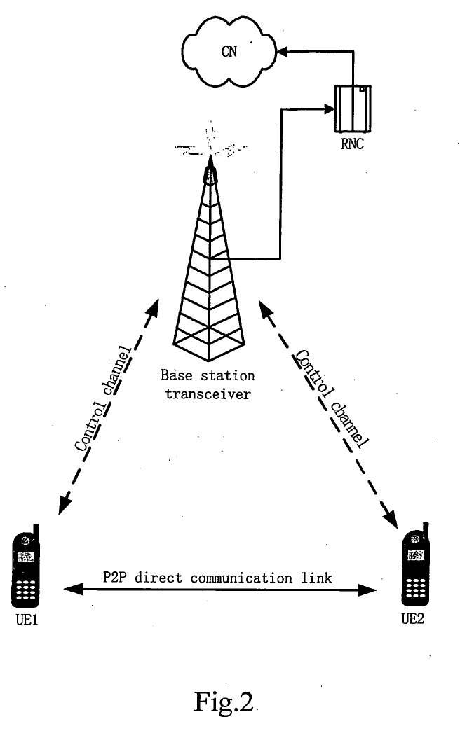

FIG. 3 is a schematic diagram illustrating various interfering signals caused by introducing P2P communication mode in TD-SCDMA systems;

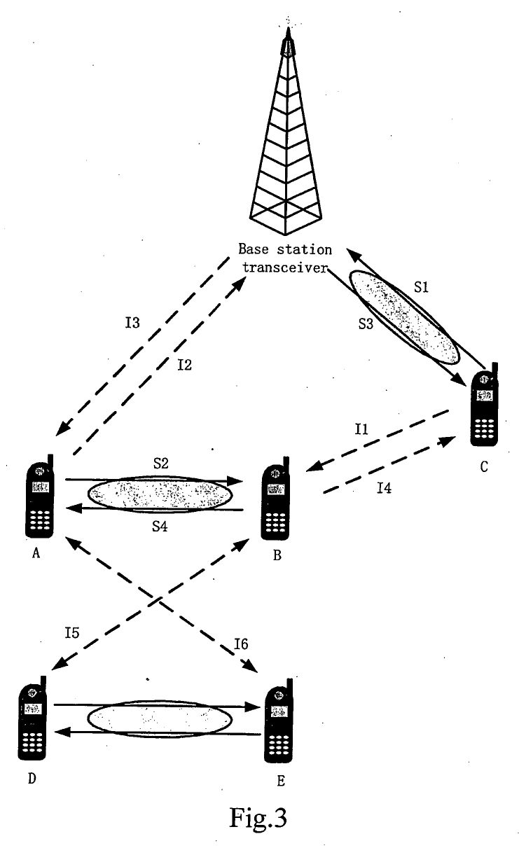

FIG. 4 illustrates the code group allocation in TD-SCMDA systems;

FIG. 5 illustrates the auto-correlation and cross-correlation characteristics of scrambling codes in TD-SCDMA systems;

FIG. 6 illustrates the method for mitigating P2P interference by using scrambling codes to be executed by UE1, UE2 and the UTRAN in accordance with the present invention;

FIG. 7 illustrates the hardware structure of UE1, UE2 and the UTRAN for mitigating P2P interferences by using scrambling codes in accordance with the present invention.

### DETAILED DESCRIPTION OF THE INVENTION

The method for mitigating P2P interference in the present invention, performs scrambling operation on the P2P signals to be transmitted, by exploiting unused scrambling codes of the cell where the P2P UEs are camping and its adjacent cells, thus interfering signals caused by introducing P2P communication can be mitigated because scrambling codes have good characteristics of auto-correlation and cross-correlation.

The following section will first give a brief introduction about scrambling codes and their auto-correlation and cross-correlation characteristics involved in the present invention, by taking TD-SCDMA system as an example.

Scrambling code is a series of alphanumeric sequences with fixed length (for example, TD-SCDMA system adopts scrambling sequences with length as 16). Data scrambling operation is to perform multiplication operation on spread data with scrambling code sequence chip by chip after data symbols are spread. Different from spreading operation or namely channelization operation that spreads signal bandwidth for distinguishing different subscribers (code division channel), scrambling operation is to specify cell property of the signal and won't change signal bandwidth.

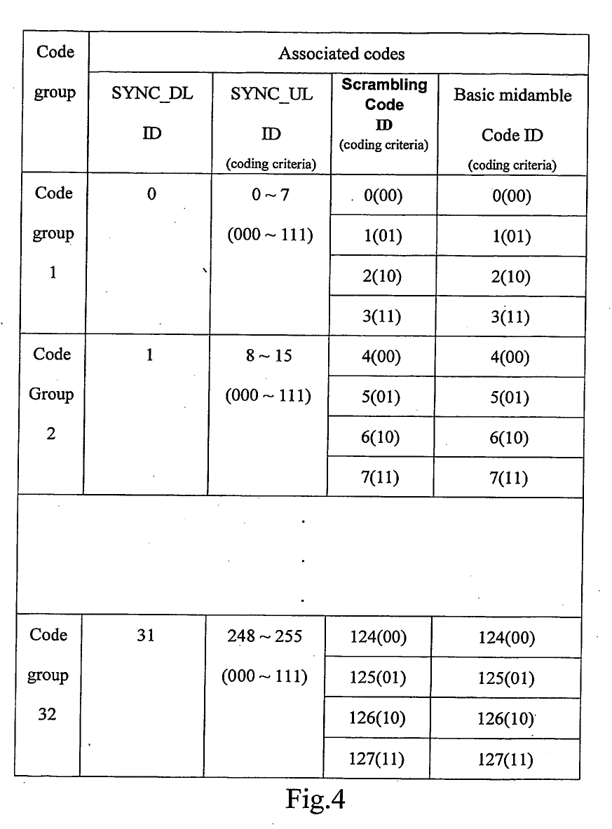

In TD-SCDMA system, there are totally 128 scrambling codes defined. These scrambling codes, together with 32 SYNC_DL codes, 256 SYNC_UL codes and 128 Midamble codes, are divided into 32 code groups. Each code group is composed of 1 SYNC_DL code, 8 SYNC_UL codes, 4 Midamble codes and 4 scrambling codes, as shown in FIG. 4. Different adjacent cells use different code groups. For a UE, once the SYNC_DL code used by a cell is identified, we can also know the related SYNC_UL codes, Midamble codes and scrambling codes used by the cell.

In TD-SCDMA systems, a UE obtains the code group usage information of its cell through cell search procedure. First, the UE searches for the SYNC_DL code in DWPTS by using MF (match filter). Then, the UE can identify the code group used by the cell, i.e. the 8 SYNC_UL codes, 4 Midamble codes and 4 scrambling codes, according to the SYNC_DL code.

During cell search phase, the UE can obtain the code group usage information of the cell where it is camping, by using the above method, as well as the code group usage information of its adjacent cells through reading the system information broadcast over the BCH.

The base station and UEs in each cell have limited transmission power, so the UEs camping on a cell can only receive radio signals from its cell and adjacent cells at most. Thus, if we scramble the P2P signals to be transmitted by the UE, with scrambling codes in the redundant code groups other than the code groups allocated to its cell and adjacent cells, it won't bring much influence on communications in its cell and adjacent cells.

This invention exploits scrambling codes in the redundant code groups other than the code groups allocated to the cell where the UE camps and adjacent cells, to scramble the P2P signals to be transmitted by the UE, which effectively mitigates the above interfering signals I1, I4, I5 and I6.

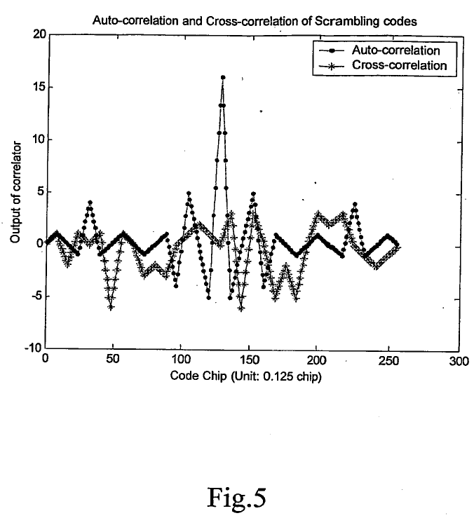

Scrambling codes can be used for distinguishing signals of different cells, and identifying P2P signals sent by UEs, due to good characteristics of auto-correlation and cross-correlation. FIG. 5 shows the auto-correlation and cross-correlation characteristics of scrambling codes in different code groups. In FIG. 5, scrambling code 0 (belonging to code group 1) and scrambling code 4 (belonging to code group 2) are taken as instances for analysis, from which we can find that the scrambling codes can reduce the undesired signal level besides the channelization code spreading gain.

For example, Table 1 shows the auto-correlation output of the scrambled signals in the correlator of the UE, taking an example that the synchronization precision scope is from −1 chip to +1 chip and the precision step is 0.125 code chip. From table 1 it can be seen, when the desired signal and the interfering signal arrive at the UE completely synchronously, the auto-correlation output gain of the desired signal is 16; when the synchronization precision is ¼ (0.25) chip, the auto-correlation output gain of the desired signal is 10.75.

Table 2 shows the cross-correlation output of the scrambled signals in the correlator of the UE. From table 2 it can be seen, when the desired signal and interfering signal arrive at the UE completely synchronously, the cross-correlation output gain of the interfering signal is 0; when the synchronization precision is ¼ (0.25) chip, the cross-correlation output gain of the interfering signal is 0.25-0.75.

TABLE 1
The auto-correlation output of the scrambled signals in the
correlator of the UE

| Synchronization shift | Auto-correlation |
|---|---|
| (chip) | output gain |
| −0.875 | −2.3750 |
| −0.75 | 0.2500 |
| −0.625 | 2.8750 |
| −0.5 | 5.5000 |
| −0.375 | 8.1250 |
| −0.25 | 10.7500 |
| −0.125 | 13.3750 |
| 0 | 16.0000 |
| 0.125 | 13.3750 |
| 0.25 | 10.7500 |
| 0.375 | 8.1250 |
| 0.5 | 5.5000 |
| 0.625 | 2.8750 |
| 0.75 | 0.2500 |
| 0.875 | −2.3750 |

TABLE 2
The cross-correlation output of the scrambled signals in the
correlator of the UE

| Synchronization shift | Cross-correlation |
|---|---|
| (chip) | output gain |
| −0.875 | 0.8750 |
| −0.75 | 0.7500 |
| −0.625 | 0.6250 |
| −0.5 | 0.5000 |
| −0.375 | 0.3750 |
| −0.25 | 0.2500 |
| −0.125 | 0.1250 |
| 0 | 0 |
| 0.125 | 0.3750 |
| 0.25 | 0.7500 |
| 0.375 | 1.1250 |
| 0.5 | 1.5000 |
| 0.625 | 1.8750 |
| 0.75 | 2.2500 |
| 0.875 | 2.6250 |

Based on the above analysis, we can see that scrambling codes do have very nice auto-correlation and cross-correlation characteristics.

If better practical results are to be achieved with the interference mitigation method by exploiting scrambling codes in the redundant code groups in accordance with the present invention, the P2P-enabled communication system should satisfy three conditions: (1) Adjust the P2P-supported radio range suitably, with the result that signals scrambled by the UE with scrambling codes in the redundant code groups can only be transferred within the cell where the UE is camping and its adjacent cells rather than in other farther cells. Thus, the UE can exploit scrambling codes in the redundant code groups other than the code groups used by the cell where the UE is camping and its adjacent cells, to scramble the P2P signals to be transmitted by the UE. (2) Synchronization scheme of the communication system should be designed, so that the interfering signal and the desired signal can arrive at the UE within a defined synchronization precision range (for example, from −¼ chip to ¼ chip). Thus, the influence caused by the interfering signal upon the system can be reduced through exploiting the good auto-correlation and cross-correlation characteristics of the above scrambling codes within a defined synchronization precision range. (3) Different scrambling codes in different redundant code groups are allocated for different channels that are affected by the above interfering signals I1, I4, I5 and I6, so that the Rx UE can correctly identify the desired traffic data. When communication systems can satisfy the above three conditions, interference of the undesired data to the communication link can be mitigated. This means, so far as the synchronization precision for the interfering signal and the desired signal to arrive at the UE can be enough, undesired traffic data within the P2P-supported radio range are scrambled signals in the Rx UE and will be processed as white noise by the Rx UE.

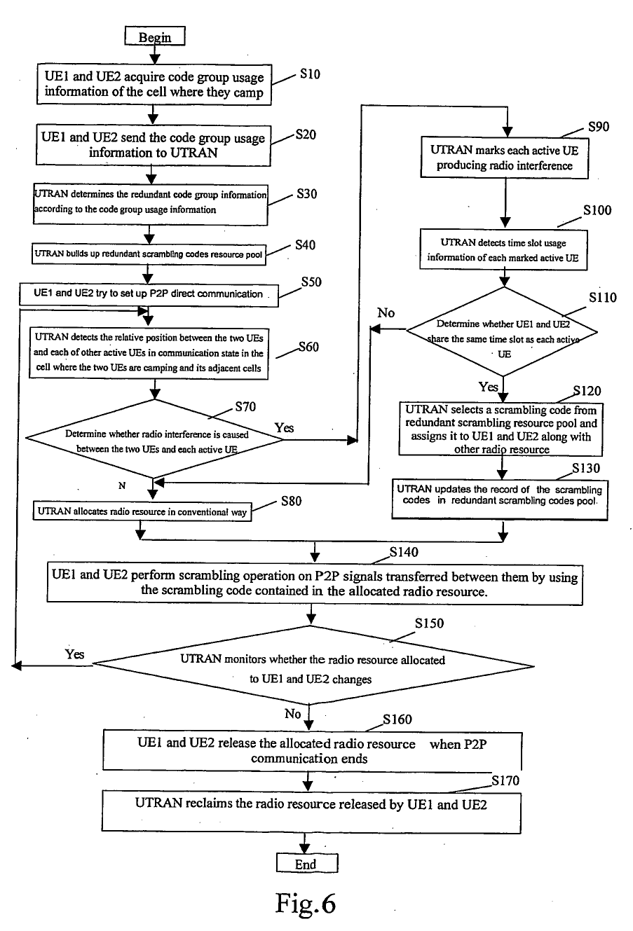

A detailed description will be given below to illustrate how the method for mitigating interferences by exploiting scrambling codes is executed by UE1, UE2 and the UTRAN in P2P-enabled communication systems in accordance with the present invention, in conjunction with FIG. 6.

UE1 and UE2 carry out cell search procedure after powering on. During cell search procedure, UE1 and UE2 who attempt to establish P2P link are generally very close, so they should be able to get the same c ell. As noted above, UE1 and UE2 can obtain the code group usage information of the cell where they are camping and its adjacent cells during cell search procedure (step S10). After obtaining the code group usage information, UE1 and UE2 send the code group usage information to the UTRAN (step S20). The UTRAN determines the redundant code group information based on the proactive knowledge of network planning, according to the received code group usage information (step 30). That means, the redundant code group information relates to the code groups not used by the cell where UE1 and UE2 are camping and its adjacent cells.

Herein, the UTRAN can obtain the code group usage information of the cell where UE1 and UE2 are camping and its adjacent cells through receiving report messages from UE1 and UE2, or determine the code group usage information according to the code group information pre-assigned to the cell where UE1 and UE2 are camping and its adjacent cells when the network was planned. The redundant code group information can be determined by the UTRAN according to the code group usage information. Alternatively, UE1 and UE2 determine their respective redundant code group information after determining their respective code group usage information, and then report the redundant code group information to the UTRAN respectively. (UE1 is generally very close to UE2, so they report the same redundant code group information.)

After determining the redundant code group information, the UTRAN builds a redundant scrambling codes resource pool, for storing the scrambling codes in the redundant code group information (step S40).

UE1 and UE2 attempt to establish P2P link according to the method and apparatus as described in the above application with the application Serial NO. 03119895.3 (step S50).

The UTRAN measures the relation position of UE1 and UE2 and each of other active UEs communicating in the cell where UE1 and UE2 are camping and its adjacent cells (step S60), and determines whether radio interference will be produced between UE1 and UE2 and each of other active UEs, according to the P2P radio range between UE1 and UE2 and the radio range between UE1 and UE2 and each of other active UEs, that is, to detect whether UE1 and/or UE2 fall within the radio range of each of other active UEs and whether each of other active UEs falls within the P2P radio range of UE1 and/or UE2 (step S70).

If radio interference won't be produced between UE1 and UE2 and each of other active UEs, the UTRAN allocates radio resource for P2P communication to UE1 and UE2 in conventional way (step S80).

If interference will be produced between UE1 and UE2 and each of other active UEs, it shows that UE1 and/or UE2 fall within the radio range of some active UE and thus the UTRAN marks the active UE, for example setting the related record flag as 1. If some active UE falls within the P2P radio range of UE1 and/or UE2, the UTRAN marks the active UE, for example, also setting the related record flag as 1 (step S90).

The UTRAN detects the timeslot usage information of each active UE that has been marked as above (step S100). Then, the UTRAN determines whether each active UE shares the same timeslot with UE1 and UE2 (step S110). If each active UE is not allocated in the same timeslot as UE1 and UE2, the UTRAN allocates radio resource for P2P communication to UE1 and UE2 as normal (step S80). That is, UE1 and UE2 scramble the P2P signals to be transmitted, by using a scrambling code in the code group to which their cell belongs. Otherwise, if each active UE is allocated in the same timeslot as UE1 and/or UE2, the UTRAN selects a redundant scrambling code from the above redundant scrambling codes resource pool, and allocates it to UE1 and UE2 along with radio resource such as timeslot, channelization code and etc (step S120). After selecting the scrambling code from the redundant scrambling codes resource pool and allocating it to UE1 and UE2, the UTRAN updates the scrambling code record in the redundant scrambling codes resource pool (step S130).

UE1 and UE2 scramble the P2P signals to be transferred between UE1 and UE2, by exploiting the above radio resource including scrambling code allocated by the UTRAN, so as to enable P2P communication via the P2P link (step S140). During P2P communication procedure, the UTRAN keeps on monitoring whether the radio resource allocated for the P2P link will change (step S150). The scrambling code for the P2P link will maintain the same during the communication unless radio resource is changed for the P2P link, especially when timeslot is changed. If the radio resource allocated for the P2P link changes, the UTRAN iterates the above steps from S60 to S150, to judge whether a new scrambling code needs to be allocated to UE1 and UE2.

When P2P communication ends, UE1 and UE2 release the radio resource including the scrambling code (step S160), and update the scrambling code record in the above redundant scrambling codes resource pool (step S170).

The above method for supporting P2P communication in TD-SCDMA systems as described in conjunction with FIG. 4, FIG. 5 and FIG. 6 in accordance with the present invention, can be implemented in computer software, or hardware, or in combination of software and hardware.

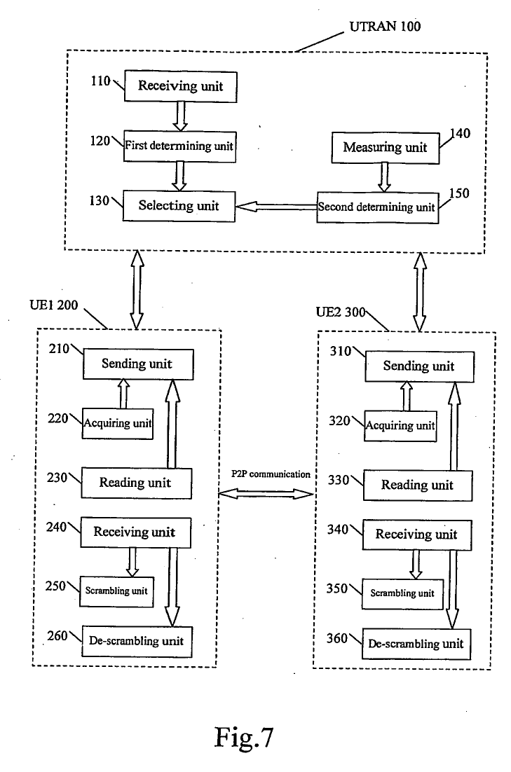

FIG. 7 illustrates the structure of UE1 and UE2 and the UTRAN for mitigating P2P interferences implemented in hardware. In UE1 200, an acquiring unit 220 acquires the code group usage information of the cell where UE1 is camping through cell search procedure; reading unit 230 reads the code group usage information of the adjacent cells through adjacent cell search procedure; sending unit 210 sends the code group usage information of the cell where UE1 is camping and its adjacent cells to UTRAN 100. Similarly, in UE2 300, acquiring unit 320 acquires the code group usage information of the cell where UE2 is camping through cell search procedure; reading unit 330 reads the code group usage information of the adjacent cells through adjacent cell search procedure; sending unit 310 sends the code group usage information of the cell where UE2 is camping and its adjacent cells to UTRAN 100. Receiving unit 110 in UTRAN 100, receives code group usage information of the cell where UE1 or UE2 are camping and its adjacent cells from UE1 and UE2; first determining unit 120 determines the redundant code group information according to the code group usage information. The first determining unit 120 can also determine the redundant code group information according to the code group usage information pre-allocated to the cell where UE1 and UE2 are camping and its adjacent cells.

A measuring unit 140 measures the relative position between UE1 and UE2 and each of other active UEs in communication state in the cell where said two UEs are camping and its adjacent cells. When radio interferences are caused between UE1 and/or UE2 and several active UEs, that is, when UE1 and/or UE2 fall within the radio range of the several active UEs and the several active UEs fall within the radio range of UE1 and/or UE2, a second determining unit 150 further determines whet her UE1 and/or UE2 and the several active UEs are allocated in the same timeslot according to the relative position; if the second determining unit 150 determines UE1 and/or UE2 and one of the several active UEs are allocated in the same timeslot, selecting unit 130 selects a scrambling code from the redundant code group information and assigning it to UE1 and UE2, so that the two UEs can scramble the P2P signals to be transferred between said two UEs by using the scrambling code.

Receiving units 240 and 340 in UE1 and UE2, respectively receive the above scrambling code allocated by the UTRAN. Let's suppose UE1 is transmitting P2P signals to UE2, scrambling unit 250 in UE1 scrambles the P2P signals to be transmitted by using the scrambling code, and transmits the scrambled P2P signals to UE2 via sending unit 210. Receiving unit 340 in UE2, receives the scrambled P2P signals, and de-scrambles the received scrambled P2P signals by using the above allocated scrambling code through de-scrambling unit 360, to obtain the original signals from UE1. Contrarily, if UE2 transmits P2P signals to UE1, UE2 and UE1 will scramble or de-scramble the P2P signals between them by respectively using scrambling unit 350 and de-scrambling unit 260.

### INDUSTRIAL APPLICABILITY OF THE INVENTION

As described above, with regard to the P2P interference mitigation method in P2P-enabled communication systems as provided in the present invention, P2P signals to be transmitted by the UE are scrambled by using scrambling codes in the redundant c ode groups other than the code groups allocated to its cell and adjacent cells, which effectively mitigates the above interfering signals I1, I4, I4 and I6. Furthermore, it can mitigate interfering signals I2 and I3 effectively.

It is to be understood by those skilled in the art that the P2P interference mitigation method and apparatus in P2P-enabled communication systems as disclosed in this invention is not limited herein for TD-SCDMA systems, but also applicable to be used for multi-hop communication and ad hoc communication in CDMA systems.

It is also to be understood by those skilled in the art that the P2P interference mitigation method and apparatus in P2P-enabled communication systems as disclosed in this invention can be modified considerably without departing from the spirit and scope of the invention as defined by the appended claims.

1. A method for mitigating P2P interferences, performed by a network system, comprising steps of:
(a) determining the redundant code group information, according to the code group usage information of the cell on which two UEs (User Equipments) attempting to establish P2P link camp and its adjacent cells;
(b) selecting a scrambling code from the redundant code group information and assigning it to the two UEs, so that the two UEs can perform scrambling operation on P2P signals to be transferred between the two UEs by using the scrambling code.

2. The method as claim 1, further comprising:
(i) measuring the relative position between said two UEs and each of other active UEs in communication state in the cell where said two UEs are camping and its adjacent cells;
(ii) if at least one of said two UEs causes radio interference with at least one of said active UEs according to the relative position, further determining whether said UE and said active UE are assigned in the same timeslot;
wherein said step (b) is executed if said UE and said active. UE are assigned in the same timeslot.

3. The method as claim 2, wherein step (a) includes:
(a1) receiving the code group usage information of said camping cell and its adjacent cells transmitted by said two UEs;
(a2) determining said redundant code group information according to said code group usage information.

4. The method as claim 2, wherein step (a) includes:
determining the redundant code group information according to the code group usage information pre-assigned to said camping cell and its adjacent cells.

5. The method as claim 2, wherein step (i) includes:
detecting whether said two UEs fall within the radio range of each of said active UEs;
detecting whether each of said active UEs falls with in the radio range of said two UEs.

6. The method as claim 2, further comprising: (c) reclaiming said scrambling code when P2P communication ends.

7. A method for mitigating P2P interferences, performed by a UE (User Equipment), comprising steps of:
(A) acquiring the code group usage information of the cell where the UE is camping through cell search procedure;
(B) reading the code group usage information of the adjacent cells through adjacent cell search procedure;
(C) sending the code group usage information of the cell where the UE is camping and its adjacent cells to a network system.

8. The method as claim 7, further comprising:
(D) receiving a scrambling code assigned by said network system, the scrambling code being assigned to the UE by said network system through selecting from the redundant code group information determined by said network system according to said code group usage information.

9. The method as claim 8, further comprising steps of:
performing scrambling operation on P2P signals to be sent by the UE by using said scrambling code;
sending the scrambled signals to another UE having established P2P link with the UE.

10. The method as claim 8, further comprising steps of:
receiving the scrambled P2P signals from another UE having established P2P link with the UE, wherein the scrambled P2P signals is scrambled by the another UE by using a scrambling code assigned by said network system;
de-scrambling the scrambled P2P signals to obtain information from said another UE by using said scrambling code assigned to the UE.

11. A network system capable of mitigating P2P interferences, comprising:
a first determining unit, for determining the redundant code group information according to the code group usage information of the cell where two UEs attempting to establish P2P link are camping and its adjacent cells;
a selecting unit, for selecting a scrambling code from the redundant code group information and assigning it to the two UEs, so that the two UEs can perform scrambling operation by using the scrambling code on P2P signals to be transferred between the two UEs.

12. The network system as claim 11, further comprising:
a measuring unit, for measuring the relative position between said two UEs and each of other active UEs in communication state in the cell where said two UEs are camping and its adjacent cells;
a second determining unit, for when at least one of said two UEs causes radio interference with at least one of said active UEs, further determining whether said UE and said active UE are assigned in the same timeslot according to the relative position;
said selecting unit, for selecting said scrambling code from said redundant code group information when the second determining unit determines that said UE and said active UE are assigned in the same timeslot.

13. The network system as claim 12, further comprising:
a receiving unit, for receiving the code group usage information of said camping cell and its adjacent cells transmitted by said two UEs;
said first determining unit, for determining said redundant code group information according to said code group usage information.

14. The network system as claim 12, wherein said first determining unit determines the redundant code group information according to the code group usage information pre-assigned for said camping cell and its adjacent cells.

15. The network system as claim 12, wherein said measuring unit, for measuring whether said two UEs fall within the radio range of each of said active UEs, and measuring whether each of said active UEs falls within the radio range of said two UEs.

16. A UE (User Equipment), comprising:
an acquiring unit, for acquiring the code group usage information of the cell where the UE is camping through cell search procedure;
a reading unit, for reading the code group usage information of the adjacent cells through adjacent cell search procedure;
a sending unit, for sending the code group usage information of the cell where the UE is camping and its adjacent cells to a network system.

17. The UE as claim 16, further comprising:
a receiving unit, for receiving a scrambling code assigned by said network system, the scrambling code being assigned to the UE by said network system through selecting from the redundant code group information determined by said network system according to said code group usage information.

18. The UE as claim 17, further comprising:
a scrambling unit, for performing scrambling operation on P2P signals to be sent by the UE by using the scrambling code;
said sending unit, for sending the scrambled signals to the other UE having established P2P link with the UE.

19. The UE as claim claim 17, wherein, said receiving unit receives scrambled P2P signals from another UE having established P2P link with the UE, the scrambled P2P signals is scrambled by the another UE by using a scrambling code assigned by said network system; the UE further comprising:
a de-scrambling unit, for de-scrambling said scrambled P2P signals to obtain information from said another UE by using said sc rambling code assigned to the UE.
